(19) United States
(12) Patent Application Publication
(10) Pub. No.: US 2024/0172220 A1
(43) Pub. Date: May 23, 2024

(54) METHOD AND DEVICE IN NODES USED FOR WIRELESS COMMUNICATION

(71) Applicants: Yang HU, SHANGHAI (CN); Xiaobo ZHANG, Shanghai (CN)

(72) Inventors: Yang HU, SHANGHAI (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/510,682

(22) Filed: Nov. 16, 2023

(30) Foreign Application Priority Data
Nov. 23, 2022 (CN) 202211477116.5

(51) Int. Cl. H04W 72/1268

(52) U.S. Cl. CPC H04W 72/1268

(57) ABSTRACT

A first receiver receives a first signaling, the first signaling is used to determine a target radio resource pool; and a first transmitter transmits first information; whether the first transmitter transmits a PUSCH in the target radio resource pool is related to at least one of the first information or whether the target radio resource pool has an overlapping with a characteristic resource, and the characteristic resource is a resource for at least one type of UCI; when any of a first condition or a second condition is satisfied, the first transmitter transmits a PUSCH in the target radio resource pool; the first condition comprises that the target radio resource pool has an overlapping with a characteristic resource, and the second condition comprises that the first information indicates transmitting a PUSCH in the target radio resource pool.

### CROSS REFERENCE TO RELATED APPLICATIONS

This application claims the priority benefit of Chinese Patent Application No. 202211477116.5, filed on Nov. 23, 2022, the full disclosure of which is incorporated herein by reference.

### BACKGROUND

### Technical Field

The present application relates to transmission methods and devices in wireless communication systems, and in particular to a transmission method and device of a radio signal in a wireless communication system supporting cellular networks.

### Related Art

Extended Reality (XR) is considered a highly promising technology, and the best form and development trend for promoting large-scale applications of XR would become one of the typical applications of future communications: support for XR services in 5G New Radio (NR) is an important aspect of system design. Based on the service characteristics of XR, enhancing uplink transmission of a Configured Grant (CG) is an effective means to achieve support for XR: how to determine whether a PUSCH corresponding to the enhanced CG is transmitted or not is a key issue that must be considered.

### SUMMARY

To address the above problem, the present application provides a solution. It should be noted that the above description adopts XR as an example: the present application is also applicable to other scenarios, such as Enhanced Mobile Broadband (eMBB), Ultra Reliable and Low Latency Communication (URLLC), Multicast Broadcast Services (MBS), Internet of Things (IOT), and the Internet of Vehicles, non-terrestrial networks (NTN), shared spectrum, where similar technical effects can be achieved. In addition, the adoption of a unified solution in different scenarios (including but not limited to XR, eMBB, URLLC, MBS, IoT, Internet of Vehicles, NTN, shared spectrum) also helps to reduce hardware complexity and cost, or improve performance. If no conflict is incurred, embodiments in any node in the present application and the characteristics of the embodiments are also applicable to any other node, and vice versa. And the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
receiving a first signaling, the first signaling being used to determine a target radio resource pool; and
transmitting first information;
herein, the first information is used to indicate whether a PUSCH is transmitted in the target radio resource pool: whether a PUSCH is transmitted in the target radio resource pool is related to at least one of the first information or whether the target radio resource pool has an overlapping with a characteristic resource, and the characteristic resource is a resource for at least one type of UCI: when any of a first condition or a second condition is satisfied, transmit a PUSCH in the target radio resource pool: the first condition comprises that the target radio resource pool has an overlapping with a characteristic resource, and the second condition comprises that the first information indicates transmitting a PUSCH in the target radio resource pool.

In one embodiment, advantages of the above method comprise: improving the performance of UCI feedback.

In one embodiment, advantages of the above method comprise: improving the transmission performance of user data.

In one embodiment, advantages of the above method comprise: simplifying the system design and reducing detection complexity on the base station side.

In one embodiment, advantages of the above method comprise: avoiding inconsistent understanding between communication parties on whether a PUSCH is transmitted or not.

In one embodiment, advantages of the above method comprise: being conducive to meeting delay requirements of services.

In one embodiment, advantages of the above method comprise: improving resource utilization.

In one embodiment, advantages of the above method comprise: having good compatibility.

In one embodiment, advantages of the above method comprise: causing minor changes to the existing 3GPP standard.

According to one aspect of the present application, the above method is characterized in that
a first condition set comprises at least the first condition and the second condition: when any condition in the first condition set is satisfied, transmit a PUSCH in the target radio resource pool: when all conditions in the first condition set are not satisfied, do not transmitting a PUSCH in the target radio resource pool.

According to one aspect of the present application, the above method is characterized in that
when the first condition is satisfied and the first information indicates that a PUSCH is not transmitted in the target radio resource pool, transmit a PUSCH in the target radio resource pool.

According to one aspect of the present application, the above method is characterized in that
when the first condition is not satisfied and the first information indicates that a PUSCH is not transmitted in the target radio resource pool, do not transmitting a PUSCH in the target radio resource pool.

According to one aspect of the present application, the above method is characterized in that
the first signaling is used to determine multiple radio resource pools, the target radio resource pool is one of the multiple radio resource pools, and a radio resource pool other than the target radio resource pool among the multiple radio resource pools is used to transmit the first information.

According to one aspect of the present application, the above method is characterized in that
the first information comprises a bitmap, and any bit in the bitmap is used to indicate whether a PUSCH is transmitted in one of the multiple radio resource pools.

According to one aspect of the present application, the above method is characterized in that
the multiple radio resource pools are respectively multiple PUSCH occasions, the multiple radio resource pools are in a same CG period, the first information is transmitted in a first one of the multiple PUSCH occasions, and the multiple radio resource pools do not overlap with each other in time domain.

According to one aspect of the present application, the above method is characterized in that
the target radio resource pool is a PUSCH occasion.

According to one aspect of the present application, the above method is characterized in that the target radio resource pool is a CG PUSCH occasion.

The present application provides a method in a second node for wireless communications, comprising: transmitting a first signaling, the first signaling being used to determine a target radio resource pool; and
receiving first information;
herein, the first information is used to indicate whether a PUSCH is transmitted in the target radio resource pool: whether a PUSCH is received in the target radio resource pool is related to at least one of the first information or whether the target radio resource pool has an overlapping with a characteristic resource, and the characteristic resource is a resource for at least one type of UCI: when any of a first condition or a second condition is satisfied, receive a PUSCH in the target radio resource pool: the first condition comprises that the target radio resource pool has an overlapping with a characteristic resource, and the second condition comprises that the first information indicates transmitting a PUSCH in the target radio resource pool.

According to one aspect of the present application, the above method is characterized in that
a first condition set comprises at least the first condition and the second condition: when any condition in the first condition set is satisfied, receive a PUSCH in the target radio resource pool: when all conditions in the first condition set are not satisfied, discard receiving a PUSCH in the target radio resource pool.

According to one aspect of the present application, the above method is characterized in that
when the first condition is satisfied and the first information indicates that a PUSCH is not transmitted in the target radio resource pool, receive a PUSCH in the target radio resource pool.

According to one aspect of the present application, the above method is characterized in that
when the first condition is not satisfied and the first information indicates that a PUSCH is not transmitted in the target radio resource pool, discard receiving a PUSCH in the target radio resource pool.

According to one aspect of the present application, the above method is characterized in that
the first signaling is used to determine multiple radio resource pools, the target radio resource pool is one of the multiple radio resource pools, and the first information is received in a radio resource pool other than the target radio resource pool among the multiple radio resource pools.

According to one aspect of the present application, the above method is characterized in that
the first information comprises a bitmap, and any bit in the bitmap is used to indicate whether a PUSCH is transmitted in one of the multiple radio resource pools.

According to one aspect of the present application, the above method is characterized in that
the multiple radio resource pools are respectively multiple PUSCH occasions, the multiple radio resource pools are in a same CG period, the first information is received in a first one of the multiple PUSCH occasions, and the multiple radio resource pools do not overlap with each other in time domain.

According to one aspect of the present application, the above method is characterized in that
the target radio resource pool is a PUSCH occasion.

According to one aspect of the present application, the above method is characterized in that
the target radio resource pool is a CG PUSCH occasion.

The present application provides a first node for wireless communications, comprising:
a first receiver, receiving a first signaling, the first signaling being used to determine a target radio resource pool; and
a first transmitter, transmitting first information;
herein, the first information is used to indicate whether a PUSCH is transmitted in the target radio resource pool: whether the first transmitter transmits a PUSCH in the target radio resource pool is related to at least one of the first information or whether the target radio resource pool has an overlapping with a characteristic resource, and the characteristic resource is a resource for at least one type of UCI: when any of a first condition or a second condition is satisfied, the first transmitter transmits a PUSCH in the target radio resource pool: the first condition comprises that the target radio resource pool has an overlapping with a characteristic resource, and the second condition comprises that the first information indicates transmitting a PUSCH in the target radio resource pool.

The present application provides a second node for wireless communications, comprising:
a second transmitter, transmitting a first signaling, the first signaling being used to determine a target radio resource pool; and
a second receiver, receiving first information;
herein, the first information is used to indicate whether a PUSCH is transmitted in the target radio resource pool: whether the second receiver receives a PUSCH in the target radio resource pool is related to at least one of the first information or whether the target radio resource pool has an overlapping with a characteristic resource, and the characteristic resource is a resource for at least one type of UCI: when any of a first condition or a second condition is satisfied, the second receiver receives a PUSCH in the target radio resource pool: the first condition comprises that the target radio resource pool has an overlapping with a characteristic resource, and the second condition comprises that the first information indicates transmitting a PUSCH in the target radio resource pool.

### BRIEF DESCRIPTION OF THE DRAWINGS

Other features, objects and advantages of the present application would become more apparent from the detailed description of non-restrictive embodiments taken in conjunction with the following drawings:

FIG. 1 illustrates a flowchart of the processing of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application:

FIG. 4 illustrates a schematic diagram of a first communication device and a second communication device according to one embodiment of the present application:

FIG. 5 illustrates a flowchart of signal transmission according to one embodiment of the present application:

FIG. 6 illustrates a schematic diagram of a relation between a first condition set and whether a PUSCH is transmitted in a target radio resource pool according to one embodiment of the present application:

FIG. 7 illustrates a schematic diagram of relations among a first signaling, multiple radio resource pools, a target radio resource pool as well as first information according to one embodiment of the present application;

FIG. 8 illustrates a schematic diagram of first information according to one embodiment of the present application:

FIG. 9 illustrates a schematic diagram of relations among multiple radio resource pools, multiple PUSCH

occasions, a target radio resource pool as well as first information according to one embodiment of the present application;

FIG. 10 illustrates a schematic diagram of relations among a first signaling, multiple radio resource pools, multiple PUSCH occasions, a target radio resource pool as well as first information according to one embodiment of the present application:

FIG. 11 illustrates a structure block diagram of a processor in a first node according to one embodiment of the present application:

FIG. 12 illustrates a structure block diagram of a processor in second node according to one embodiment of the present application.

### DESCRIPTION OF THE EMBODIMENTS

The technical solution of the present application would be further described in detail below in combination with the drawings. It should be noted that, in the case of no conflict, the embodiments of the present application and the features in the embodiments may be combined with each other arbitrarily.

### Embodiment 1

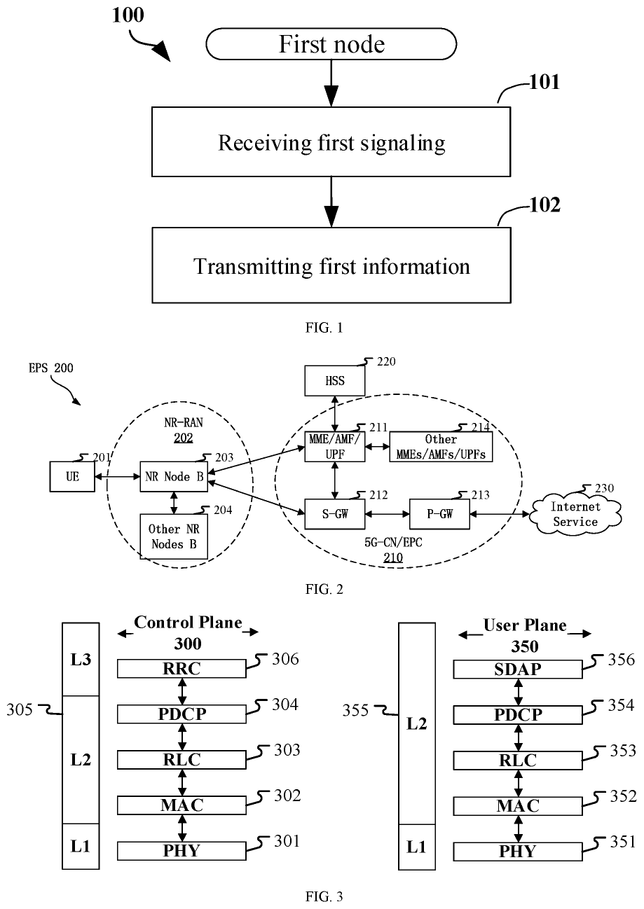

Embodiment 1 illustrates a flowchart of processing of a first node according to one embodiment of the present application, as shown in FIG. 1.

In Embodiment 1, the first node in the present application receives a first signaling in step 101: transmits first information in step 102.

In embodiment 1, the first signaling is used to determine a target radio resource pool: the first information is used to indicate whether a PUSCH is transmitted in the target radio resource pool: whether a PUSCH is transmitted in the target radio resource pool is related to at least one of the first information or whether the target radio resource pool has an overlapping with a characteristic resource, and the characteristic resource is a resource for at least one type of UCI: when any of a first condition or a second condition is satisfied, transmit a PUSCH in the target radio resource pool: the first condition comprises that the target radio resource pool has an overlapping with a characteristic resource, and the second condition comprises that the first information indicates transmitting a PUSCH in the target radio resource pool.

In one embodiment, the first signaling comprises a higher-layer parameter configuredGrantConfig.

In one embodiment, the first signaling is a higher-layer parameter configuredGrantConfig.

In one embodiment, the first signaling is Downlink control information (DCI).

In one embodiment, the first signaling is a DCI comprising a UL grant.

In one embodiment, the first signaling comprises an RRC signaling.

In one embodiment, the first signaling comprises a higher-layer parameter.

In one embodiment, the first signaling is used to configure the target radio resource pool.

In one embodiment, the first signaling is used to indicate the target radio resource pool.

In one embodiment, the first signaling explicitly indicates the target radio resource pool.

In one embodiment, the first signaling implicitly indicates the target radio resource pool.

In one embodiment, the first signaling is used to indicate frequency-domain resources occupied by the target radio resource pool.

In one embodiment, the first signaling is used to indicate time-domain resources occupied by the target radio resource pool.

In one embodiment, the first signaling is used to indicate a slot where the target radio resource pool is located.

In one embodiment, the first signaling is used to configure multiple radio resource pools, and the target radio resource pool is one of the multiple radio resource pools.

In one embodiment, at least one parameter value comprised in the first signaling is used to infer the target radio resource pool.

In one embodiment, the target radio resource pool is a PUSCH occasion.

In one embodiment, the target radio resource pool is a CG PUSCH occasion.

In one embodiment, the target radio resource pool is radio resources occupied by a PUSCH occasion.

In one embodiment, the target radio resource pool is radio resources occupied by a CG PUSCH occasion.

In one embodiment, the target radio resource pool is an occasion used for a PUSCH transmission.

In one embodiment, the target radio resource pool is an occasion used for a CG PUSCH transmission.

In one embodiment, the target radio resource pool is reserved for a transmission of a PUSCH.

In one embodiment, the target radio resource pool is reserved for a transmission of a CG PUSCH.

In one embodiment, from frequency domain and time domain, the target radio resource pool comprises multiple Resource Elements (REs).

In one embodiment, the first information comprises a physical-layer signaling.

In one embodiment, the first information comprises an RRC signaling.

In one embodiment, the first information is Uplink Control Information (UCI).

In one embodiment, the first information is a CG-UCI.

In one embodiment, the first information is a bit or a field in a CG UCI.

In one embodiment, the first information is carried by at least one UCI bit multiplexed onto a PUSCH.

In one embodiment, the first information is a UCI bit.

In one embodiment, the first information is represented by a bit.

In one embodiment, the first information is a bit, with a value of 0 indicating that a PUSCH is transmitted in the target radio resource pool, and a value of 1 indicating that a PUSCH is not transmitted in the target radio resource pool.

In one embodiment, the first information is a bit. “the first information indicating transmitting a PUSCH in the target radio resource pool” and “the first information being a bit with a value of 0” are equivalent or interchangeable. “the first information indicating not transmitting a PUSCH in the target radio resource pool” and “the first information being a bit with a value of 1” are equivalent or interchangeable.

In one embodiment, the first information is a bit, with a value of 1 indicating that a PUSCH is transmitted in the target radio resource pool, and a value of 0 indicating that a PUSCH is not transmitted in the target radio resource pool.

In one embodiment, “the first information indicating transmitting a PUSCH in the target radio resource pool” and “the first information being a bit with a value of 1” are equivalent or interchangeable, and “the first information indicating not transmitting a PUSCH in the target radio resource pool” and “a value of the bit being 0” are equivalent or interchangeable.

In one embodiment, the first information is a field, and the field comprises multiple bits.

In one embodiment, the first information is a field, the field comprises multiple bits, at least one value in a value range of the field indicates transmitting a PUSCH in the target radio resource pool, and at least another value in a value range of the field indicates not transmitting a PUSCH in the target radio resource pool.

In one embodiment, the first information explicitly indicates whether a PUSCH is transmitted in the target radio resource pool.

In one embodiment, the first information implicitly indicates whether a PUSCH is transmitted in the target radio resource pool.

In one embodiment, transmitting a PUSCH in the target radio resource pool refers to: the target radio resource pool is used to transmit a PUSCH.

In one embodiment, the first node transmitting a PUSCH in the target radio resource pool comprises the following meaning: the first node transmits at least one transport block in a PUSCH, and the target radio resource pool comprises radio resources occupied by the PUSCH.

In one embodiment, the first node transmitting a PUSCH in the target radio resource pool comprises the following meaning: the first node transmits at least one bit in a PUSCH, and the target radio resource pool comprises radio resources occupied by the PUSCH.

In one embodiment, the first node transmitting a PUSCH in the target radio resource pool comprises the following meaning: the first node transmits a radio signal in a PUSCH, and the target radio resource pool comprises radio resources occupied by the PUSCH.

In one embodiment, the first node transmitting a PUSCH in the target radio resource pool comprises the following meaning: the first node transmits at least one bit through a PUSCH, and the target radio resource pool comprises radio resources occupied by the PUSCH.

In one embodiment, the first node transmitting a PUSCH in the target radio resource pool comprises the following meaning: the target radio resource pool comprises radio resources occupied by a signal transmitted through a PUSCH.

In one embodiment, whether the first node transmits a PUSCH in the target radio resource pool is related to both the first information, and whether the target radio resource pool has an overlapping with characteristic resources.

In one embodiment, whether the first node transmits a PUSCH in the target radio resource pool is related to at least a latter of the first information, and whether the target radio resource pool has an overlapping with characteristic resources.

In one embodiment, whether the first node transmits a PUSCH in the target radio resource pool depends on at least one of the first information or whether the target radio resource pool has an overlapping with characteristic resources.

In one embodiment, whether the first node transmits a PUSCH in the target radio resource pool depends on at least a latter of the first information, and whether the target radio resource pool has an overlapping with characteristic resources.

In one embodiment, whether the first node transmits a PUSCH in the target radio resource pool depends on the first information, and whether the target radio resource pool has an overlapping with characteristic resources.

In one embodiment, a PUSCH transmitted in the target radio resource pool is a CG Physical uplink shared channel (PUSCH).

In one embodiment, the expression of “whether a PUSCH is transmitted in the target radio resource pool” refers to: whether a CG PUSCH is transmitted in the target radio resource pool.

In one embodiment, the expression of “the first information being used to indicate whether a PUSCH is transmitted in the target radio resource pool” refers to: the first information is used to indicate whether the target radio resource pool is used to transmit a CG PUSCH.

In one embodiment, the target radio resource pool having no overlapping with characteristic resources refers to: the target radio resource pool has no overlapping with characteristic resources in time domain.

In one embodiment, the target radio resource pool having an overlapping with characteristic resources refers to: the target radio resource pool has an overlapping with characteristic resources in time domain.

In one embodiment, the target radio resource pool is configured for uplink transmission without dynamic grant.

In one embodiment, the characteristic resources are PUCCH resources.

In one embodiment, a characteristic resource comprises a PUCCH resource.

In one embodiment, the meaning of the expression of “the characteristic resources are resources for at least one UCI” is: the characteristic resources are PUCCH resources.

In one embodiment, the meaning of the expression of “the characteristic resources are resources for at least one UCI” is: the characteristic resources are PUCCH resources used for at least a HARQ-ACK.

In one embodiment, the meaning of the expression of “the characteristic resources are resources for at least one UCI” is: the characteristic resources are PUCCH resources used for at least one of HARQ-ACK. SR, and Channel State Information (CSI) report.

In one embodiment, the meaning of the expression of “the characteristic resources are resources for at least one UCI” is: the characteristic resources are PUCCH resources used for at least Hybrid automatic repeat request acknowledgement (HARQ-ACK) and Scheduling request (SR).

In one embodiment, the expression of “the first condition comprising that the target radio resource pool having an overlapping with characteristic resources” comprises: the first condition comprises: if the target radio resource pool is used to transmit a PUSCH, a UCI bit would be multiplexed into the PUSCH.

In one embodiment, the expression of “the first condition comprising that the target radio resource pool having an overlapping with characteristic resources” comprises: the first condition comprises: if the target radio resource pool is used to transmit a PUSCH, at least a HARQ-ACK bit would be multiplexed into the PUSCH.

In one embodiment, the first condition is: the target radio resource pool has an overlapping with characteristic resources.

In one embodiment, the first condition is: the target radio resource pool has an overlapping with a characteristic resource.

In one embodiment, the first condition is: the target radio resource pool has an overlapping with multiple characteristic resource.

In one embodiment, the first condition is: the target radio resource pool has an overlapping with at least one characteristic resource.

In one embodiment, the first condition is: the target radio resource pool has an overlapping with any characteristic resource.

In one embodiment, the first condition only comprises: the target radio resource pool has an overlapping with characteristic resources.

In one embodiment, the first condition comprises multiple sub-conditions, and the first condition being satisfied refers to all sub-conditions comprised in the first condition are satisfied: one of the multiple sub-conditions is that the target radio resource pool has an overlapping with characteristic resources.

In one subembodiment of the above embodiment, another sub-condition in the multiple sub-conditions is: if the target radio resource pool is used to transmit a PUSCH, then at least a HARQ-ACK bit would be multiplexed into the PUSCH.

In one subembodiment of the above embodiment, another sub-condition in the multiple sub-conditions is: if the target radio resource pool is used to transmit a PUSCH, then a UCI bit would be multiplexed into the PUSCH.

In one subembodiment of the above embodiment, another sub-condition in the multiple sub-conditions is: timeline conditions for UCI multiplexing into PUSCH are met.

In one subembodiment of the above embodiment, another sub-condition in the multiple sub-conditions is: a UCI would be multiplexed into the target radio resource pool.

In one subembodiment of the above embodiment, another sub-condition in the multiple sub-conditions is: at least HARQ-ACK information would be multiplexed into the target radio resource pool.

In one subembodiment of the above embodiment, another sub-condition in the multiple sub-conditions is: a UCI would be multiplexed and transmitted in the target radio resource pool.

In one subembodiment of the above embodiment, another sub-condition in the multiple sub-conditions is: at least HARQ-ACK information would be multiplexed and transmitted in the target radio resource pool.

In one subembodiment of the above embodiment, another sub-condition in the multiple sub-conditions is: frequency-domain resources occupied by the target radio resource pool are in active uplink (UL) Bandwidth Part (BWP) on a primary cell (PCell).

In one embodiment, the meaning of the first condition being satisfied is: the target radio resource pool has an overlapping with characteristic resources.

In one embodiment, the meaning of the first condition being satisfied is: the target port resource pool has an overlapping with characteristic resources and a timeline condition for a UCI multiplexing into a PUSCH is met.

In one embodiment, the expression of “the target radio resource pool having an overlapping with characteristic resources” is: a UCI would be multiplexed into the target radio resource pool.

In one embodiment, the expression of “the target radio resource pool having an overlapping with characteristic resources” is: at least HARQ-ACK information would be multiplexed into the target radio resource pool.

In one embodiment, the expression of “the target radio resource pool having an overlapping with characteristic resources” is: a UCI would be multiplexed and transmitted in the target radio resource pool.

In one embodiment, the expression of “the target radio resource pool having an overlapping with characteristic resources” is: at least HARQ-ACK information would be multiplexed and transmitted in the target radio resource pool.

In one embodiment, the second condition is: the first information indicates transmitting a PUSCH in the target radio resource pool.

In one embodiment, the second condition only comprises: the first information indicates transmitting a PUSCH in the target radio resource pool.

In one embodiment, the second condition comprises multiple sub-conditions, and the second condition being satisfied refers that all sub-conditions comprised in the second condition are satisfied: one of the multiple sub-conditions is that the first information indicates transmitting a PUSCH in the target radio resource pool.

In one subembodiment of the above embodiment, another sub-condition in the multiple sub-conditions is: there do not exist other PUSCHs having an overlapping with the target radio resource pool in time domain.

In one subembodiment of the above embodiment, another sub-condition in the multiple sub-conditions is: the target radio resource pool has no overlapping with a DL symbol indicated by tdd-UL-DL-ConfigurationCommon or tdd-UL-DL-ConfigurationDedicated. or has no overlapping with a symbol of an SS/PBCH block with an index provided by ssb-PositionsInBurst.

In one embodiment, the meaning of the second condition being satisfied is: the first information indicates transmitting a PUSCH in the target radio resource pool.

In one embodiment, the first information at least depends on whether the target radio resource pool has an overlapping with characteristic resources.

In one embodiment, if the target radio resource pool has an overlapping with characteristic resources, the first information indicates transmitting a PUSCH in the first radio resource pool group.

In one embodiment, if the target radio resource pool has an overlapping with characteristic resources, the first information is set to indicate transmitting a PUSCH in the first radio resource pool group.

In one embodiment, if the target radio resource pool has an overlapping with characteristic resources, the first information is expected to indicate transmitting a PUSCH in the first radio resource pool group.

In one embodiment, if the first condition is satisfied, the first information indicates transmitting a PUSCH in the first radio resource pool group.

In one embodiment, if the first condition is satisfied, the first information is set to indicate transmitting a PUSCH in the first radio resource pool group.

In one embodiment, if the first condition is satisfied, the first information is expected to indicate transmitting a PUSCH in the first radio resource pool group.

In one embodiment, when the first condition is satisfied and the first information indicates that a PUSCH is not transmitted in the target radio resource pool, the first node transmits a PUSCH in the target radio resource pool.

In one embodiment, when the first condition is not satisfied and the first information indicates that a PUSCH is not transmitted in the target radio resource pool, the first node does not transmit a PUSCH in the target radio resource pool.

In one embodiment, when the second condition is satisfied, the first condition may or may not be satisfied.

In one embodiment, when the second condition is not satisfied, the first condition may or may not be satisfied.

In one embodiment, if the first condition is satisfied, then the second condition is also satisfied.

In one embodiment, if the second condition is not satisfied, then the first condition is also not satisfied.

In one embodiment, when the first condition is satisfied, the second condition may or may not be satisfied.

In one embodiment, when the first condition is not satisfied, the second condition may or may not be satisfied.

In one embodiment, the meaning of the expression of “the first information being used to indicate whether a PUSCH is transmitted in the target radio resource pool” is: the first information at least is used to indicate whether a PUSCH is transmitted in the target radio resource pool.

In one embodiment, when the first condition is satisfied and the first information indicates that a PUSCH is not transmitted in the target radio resource pool, the first node transmits a PUSCH in the target radio resource pool: when the first condition is not satisfied and the first information indicates that a PUSCH is not transmitted in the target radio resource pool, the first node does not transmit a PUSCH in the target radio resource pool.

### Embodiment 2

Embodiment 2 illustrates a schematic diagram of a network architecture according to the present application, as shown in FIG. 2.

FIG. 2 illustrates a network architecture 200 of 5G NR. Long-Term Evolution (LTE) and Long-Term Evolution Advanced (LTE-A) systems. The NR 5G or LTE network architecture 200 may be called an Evolved Packet System (EPS) 200 or other appropriate terms. The EPS 200 may comprise one or more UEs 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones. Session Initiation Protocol (SIP) phones, laptop computers. Personal Digital Assistant (PDA), satellite Radios, non-terrestrial base station communications. Satellite Mobile Communications. Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet. Intranet. IP Multimedia Subsystem (IMS) and Packet Switching Streaming Services (PSS).

In one embodiment, the UE 201 corresponds to the first node in the present application.

In one embodiment, the UE 201 corresponds to the second node in the present application.

In one embodiment, the UE 201 is a UE.

In one embodiment, the UE 201 is a UE supporting multicast.

In one embodiment, the UE 201 is a regular UE.

In one embodiment, the gNB 203 corresponds to the first node in the present application.

In one embodiment, the gNB 203 corresponds to the second node in the present application.

In one embodiment, the UE 201 corresponds to the first node in the present application, and the gNB 203 corresponds to the second node in the present application.

In one embodiment, the gNB 203 is a MarcoCellular base station.

In one embodiment, the gNB 203 is a Micro Cell base station.

In one embodiment, the gNB 203 is a PicoCell base station.

In one embodiment, the gNB 203 is a Femtocell.

In one embodiment, the gNB 203 is a base station that supports large delay differences.

In one embodiment, the gNB 203 is a flight platform.

In one embodiment, the gNB 203 is satellite equipment.

In one embodiment, the gNB 203 is a base station that enables network energy-saving enhancement.

In one embodiment, both the first node and the second node in the present application correspond to the UE 201, for example, V2X communications are executed between the first node and the second node.

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB. UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351. PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signaling in the present application is generated by the RRC sublayer 306.

In one embodiment, the first signaling in the present application is generated by the MAC sublayer 302.

In one embodiment, the first signaling in the present application is generated by the PHY 301.

In one embodiment, the first information in the present application is generated by the RRC sublayer 306.

In one embodiment, the first information in the present application is generated by the MAC sublayer 302.

In one embodiment, the first information in the present application is generated by the PHY 301.

In one embodiment, a PUSCH in the present application is generated by the PHY 301.

### Embodiment 4

Embodiment 4 illustrates a schematic diagram of a first communication device and a second communication device in the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In the transmission from the first communication device 410 to the first communication device 450, the controller/processor 475 provides header compression, encryption, packet segmentation and reordering, and multiplexing between a logical channel and a transport channel, and radio resources allocation to the second communication device 450 based on various priorities. The controller/processor 475 is also responsible for retransmission of a lost packet and a signaling to the second communication device 450. The transmitting processor 416 and the multi-antenna transmitting processor 471 perform various signal processing functions used for the L1 layer (that is. PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the second communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication device 410 to the second communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the second communication device 450 to the first communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first node in the present application comprises the second communication device 450, and the second node in the present application comprises the first communication device 410.

In one subembodiment of the above embodiment, the first node is a UE, and the second node is a UE.

In one subembodiment of the above embodiment, the first node is a UE, and the second node is a relay node.

In one subembodiment of the above embodiment, the first node is a relay node, and the second node is a UE.

In one subembodiment of the above embodiment, the first node is a UE, and the second node is a base station.

In one subembodiment of the above embodiment, the first node is a relay node, and the second node is a base station.

In one subembodiment of the above embodiment, the second node is a UE, and the first node is a base station.

In one subembodiment of the above embodiment, the second node is a relay node, and the first node is a base station.

In one subembodiment of the above embodiment, the second communication device 450 comprises: at least one controller/processor: the at least one controller/processor is responsible for HARQ operation.

In one subembodiment of the above embodiment, the first communication device 410 comprises: at least one controller/processor: the at least one controller/processor is responsible for HARQ operation.

In one subembodiment of the above embodiment, the first communication device 410 comprises: at least one controller/processor: the at least one controller/processor is responsible for error detection using ACK and/or NACK protocols as a way to support HARQ operation.

In one embodiment, the second communication device 450 comprises at least one processor and at least one memory. The at least one memory comprises computer program codes: the at least one memory and the computer program codes are configured to be used in collaboration with the at least one processor. The second communication device 450 at least: receives a first signaling, the first signaling is used to determine a target radio resource pool; and transmits first information: herein the first information is used to indicate whether a PUSCH is transmitted in the target radio resource pool: whether a PUSCH is transmitted in the target radio resource pool is related to at least one of the first information or whether the target radio resource pool has an overlapping with a characteristic resource, and the characteristic resource is a resource for at least one type of UCI: when any of a first condition or a second condition is satisfied, transmit a PUSCH in the target radio resource pool: the first condition comprises that the target radio resource pool has an overlapping with a characteristic resource, and the second condition comprises that the first information indicates transmitting a PUSCH in the target radio resource pool.

In one subembodiment of the above embodiment, the second communication device 450 corresponds to the first node in the present application.

In one embodiment, the second communication device 450 comprises a memory that stores a computer readable instruction program. The computer readable instruction program generates an action when executed by at least one processor. The action includes: receiving a first signaling, the first signaling being used to determine a target radio resource pool: and transmitting first information: herein, the first information is used to indicate whether a PUSCH is transmitted in the target radio resource pool: whether a PUSCH is transmitted in the target radio resource pool is related to at least one of the first information or whether the target radio resource pool has an overlapping with a characteristic resource, and the characteristic resource is a resource for at least one type of UCI: when any of a first condition or a second condition is satisfied, transmit a PUSCH in the target radio resource pool: the first condition comprises that the target radio resource pool has an overlapping with a characteristic resource, and the second condition comprises that the first information indicates transmitting a PUSCH in the target radio resource pool.

In one subembodiment of the above embodiment, the second communication device 450 corresponds to the first node in the present application.

In one embodiment, the first communication device 410 comprises at least one processor and at least one memory. The at least one memory comprises computer program codes: the at least one memory and the computer program codes are configured to be used in collaboration with the at least one processor. The first communication device 410 at least: transmits a first signaling, the first signaling is used to determine a target radio resource pool; and receives first information: herein, the first information is used to indicate whether a PUSCH is transmitted in the target radio resource pool: whether a PUSCH is received in the target radio resource pool is related to at least one of the first information or whether the target radio resource pool has an overlapping with a characteristic resource, and the characteristic resource is a resource for at least one type of UCI: when any of a first condition or a second condition is satisfied, receive a PUSCH in the target radio resource pool: the first condition comprises that the target radio resource pool has an overlapping with a characteristic resource, and the second condition comprises that the first information indicates transmitting a PUSCH in the target radio resource pool.

In one subembodiment of the above embodiment, the first communication device 410 corresponds to the second node in the present application.

In one embodiment, the first communication device 410 comprises a memory that stores a computer readable instruction program. The computer readable instruction program generates an action when executed by at least one processor. The action includes: transmitting a first signaling, the first signaling being used to determine a target radio resource pool: and receiving first information: herein, the first information is used to indicate whether a PUSCH is transmitted in the target radio resource pool: whether a PUSCH is received in the target radio resource pool is related to at least one of the first information or whether the target radio resource pool has an overlapping with a characteristic resource, and the characteristic resource is a resource for at least one type of UCI: when any of a first condition or a second condition is satisfied, receive a PUSCH in the target radio resource pool: the first condition comprises that the target radio resource pool has an overlapping with a characteristic resource, and the second condition comprises that the first information indicates transmitting a PUSCH in the target radio resource pool.

In one subembodiment of the above embodiment, the first communication device 410 corresponds to the second node in the present application.

In one embodiment, at least one of the antenna 452, the receiver 454, the multi-antenna receiving processor 458, the receiving processor 456, the controller/processor 459, the memory 460, or the data source 467 is used to receive the first signaling in the present application.

In one embodiment, at least one of the antenna 420, the transmitter 418, the multi-antenna transmitting processor 471, the transmitting processor 416, the controller/processor 475, or the memory 476 is used to transmit the first signaling in the present application.

In one embodiment, at least one of the antenna 452, the transmitter 454, the multi-antenna transmitting processor 468, the controller/processor 459, the memory 460 or the data source 467 is used to the first information in the present application.

In one embodiment, at least one of the antenna 420, the receiver 418, the multi-antenna receiving processor 472, the receiving processor 470, the controller/processor 475, or the memory 476 is used to receive the first information in the present application.

In one embodiment, at least one of the antenna 452, the transmitter 454, the multi-antenna transmitting processor 458, the transmitting processor 468, the controller/processor 459, the memory 460, or the data sources 467 is used to transmit a PUSCH in the present application.

In one embodiment, at least one of the antenna 420, the receiver 418, the multi-antenna receiving processor 472, the receiving processor 470, the controller/processor 475, or the memory 476 is used to receive a PUSCH in the present application.

### Embodiment 5

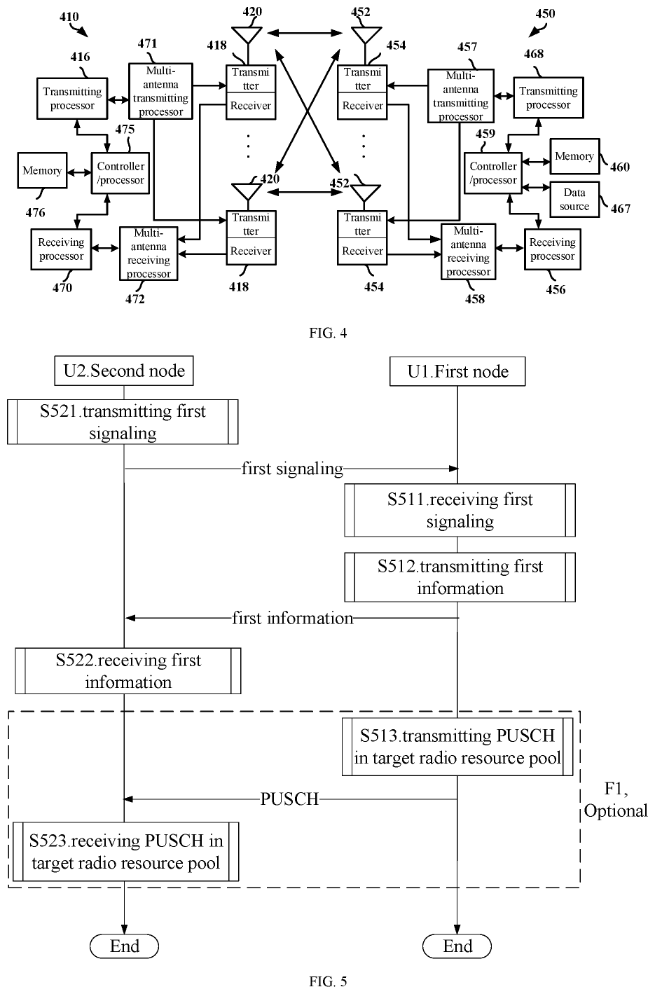

Embodiment 5 illustrates a flowchart of signal transmission according to one embodiment in the present application, as shown in FIG. 5. In FIG. 5, a first node U1 and a second node U2 are in communications via an air interface. Specifically, in FIG. 5, steps in dotted box F1 are optional.

The first node U1 receives a first signaling in step S511: transmits first information in step S512: transmits a PUSCH in a target radio resource pool in step S513.

The second node U2 transmits a first signaling in step S521: receives first information in step S522: receives a PUSCH in a target radio resource pool in step S523.

In embodiment 5, the first signaling is used to determine a target radio resource pool: the first information is used to indicate whether a PUSCH is transmitted in the target radio resource pool: whether the first node U1 transmits a PUSCH in the target radio resource pool is related to at least one of the first information or whether the target radio resource pool has an overlapping with a characteristic resource, and the characteristic resource is a resource for at least one type of UCI: when any a first condition or second condition is met, the first node U1 transmits a PUSCH in the target radio resource pool, and the second node U2 receives a PUSCH in the target radio resource pool: when the first condition is not satisfied and the first information indicates that a PUSCH is not transmitted in the target radio resource pool, the first node U1 does not transmit a PUSCH in the target radio resource pool: the first condition comprises that the target radio resource pool has an overlapping with a characteristic resource, and the second condition comprises that the first information indicates transmitting a PUSCH in the target radio resource pool.

In one subembodiment of embodiment 5, the first signaling is used to determine multiple radio resource pools, the target radio resource pool is one of the multiple radio resource pools, and a radio resource pool other than the target radio resource pool among the multiple radio resource pools is used to transmit the first information; the multiple radio resource pools are respectively multiple PUSCH occasions, and the multiple radio resource pools are in a same CG period.

In one embodiment, the first node U1 is the first node in the present application.

In one embodiment, the second node U2 is the second node in the present application.

In one embodiment, the first node U1 is a UE.

In one embodiment, the first node U1 is a base station.

In one embodiment, the second node U2 is a base station.

In one embodiment, the second node U2 is a UE.

In one embodiment, an air interface between the second node U2 and the first node U1 is a Uu interface.

In one embodiment, an air interface between the second node U2 and the first node U1 comprises a cellular link.

In one embodiment, an air interface between the second node U2 and the first node U1 is a PC5 interface.

In one embodiment, an air interface between the second node U2 and the first node U1 comprises sidelink.

In one embodiment, an air interface between the second node U2 and the first node U1 comprises a radio interface between a base station and a UE.

In one embodiment, an air interface between the second node U2 and the first node U1 comprises a radio interface between satellite and a UE.

In one embodiment, an air interface between the second node U2 and the first node U1 comprises a radio interface between a UE and a UE.

In one embodiment, a problem to be solved in the present application comprises: how to determine whether a PUSCH is transmitted in the target radio resource pool.

In one embodiment, a problem to be solved in the present application comprises: how to avoid inconsistent understanding between communication parties on whether a PUSCH is transmitted or not.

In one embodiment, a problem to be solved in the present application comprises: due to the incorrect decoding of the first information, the base station is unable to determine whether UCI is multiplexed onto a CG PUSCH.

In one embodiment, a problem to be solved in the present application comprises: how to improve the performance of UCI feedback.

In one embodiment, a problem to be solved in the present application comprises: how to handle the overlapping between a PUSCH occasion and PUCCH resources.

In one embodiment, a problem to be solved in the present application comprises: how to reduce the detection complexity on the base station side.

In one embodiment, a problem to be solved in the present application comprises: how to enable the uplink transmission of enhanced CG compatible with UCI multiplexing.

In one embodiment, steps marked by the dotted box F1 exist.

In one embodiment, steps marked by the dotted box F1 do not exist.

In one embodiment, when any of the first condition or the second condition is satisfied, step in dotted box F1 exists.

In one embodiment, when the first condition is satisfied and the first information indicates that a PUSCH is not transmitted in the target radio resource pool, steps in the dotted box F1 exist.

In one embodiment, when the first condition is not satisfied and the first information indicates that a PUSCH is not transmitted in the target radio resource pool, steps in the dotted box F1 do not exist.

In one embodiment, a first condition set comprises at least the first condition and the second condition: when any condition in the first condition set is satisfied, steps in the dotted box F1 exist: when all conditions in the first condition set are not satisfied, steps in the dotted box F1 do not exist.

### Embodiment 6

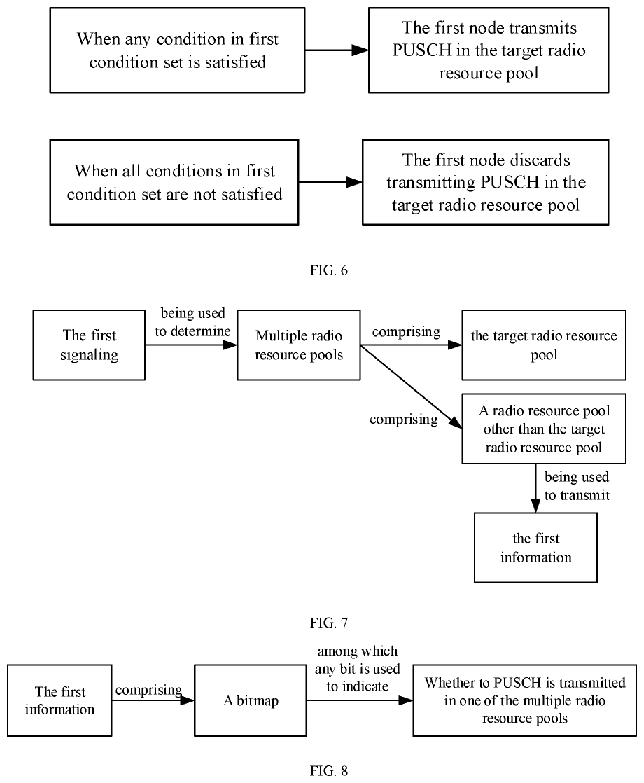

Embodiment 6 illustrates a schematic diagram of a relation between a first condition set and whether a PUSCH is transmitted in a target radio resource pool according to one embodiment of the present application, as shown in FIG. 6.

In embodiment 6, when any condition in a first condition set is satisfied, the first node transmits a PUSCH in the target radio resource pool: when all conditions in a first condition set are not satisfied, the first node does not transmit a PUSCH in the target radio resource pool: the first condition set comprises at least the first condition and the second condition.

In one embodiment, the first condition set only comprises the first condition and the second condition.

In one embodiment, the first condition set also comprises at least one condition other than the first condition and the second condition.

In one embodiment, the first condition set also comprises a condition unrelated to both the first information and whether the target radio resource pool has an overlapping with characteristic resources.

In one embodiment, the first condition set also comprises a third condition, and the third condition comprises a first PUSCH occasion in a CG period where the target radio resource pool is located.

In one embodiment, transmitting a PUSCH in the target radio resource pool refers to: the target radio resource pool is used to transmit a PUSCH.

In one embodiment, transmitting a PUSCH in the target radio resource pool refers to: the target radio resource pool is used to transmit a CG PUSCH.

In one embodiment, transmitting a PUSCH in the target radio resource pool refers to: transmitting a CG PUSCH in the target radio resource pool.

In one embodiment, discarding transmitting a PUSCH in the target radio resource pool refers to: the target radio resource pool is not used to transmit a PUSCH.

In one embodiment, discarding transmitting a PUSCH in the target radio resource pool refers to: the target radio resource pool is not used to transmit a CG PUSCH.

In one embodiment, discarding transmitting a PUSCH in the target radio resource pool refers to: not transmitting a PUSCH in the target radio resource pool.

In one embodiment, discarding transmitting a PUSCH in the target radio resource pool refers to: not transmitting a CG PUSCH in the target radio resource pool.

### Embodiment 7

Embodiment 7 illustrates a schematic diagram of relations among a first signaling, multiple radio resource pools, a target radio resource pool as well as first information according to one embodiment of the present application, as shown in FIG. 7.

In embodiment 7, the first signaling is used to determine multiple radio resource pools, the target radio resource pool is one of the multiple radio resource pools, and a radio resource pool other than the target radio resource pool among the multiple radio resource pools is used to transmit the first information.

In one embodiment, the first signaling is used to indicate the multiple radio resource pools.

In one embodiment, the first signaling explicitly indicates the multiple radio resource pool.

In one embodiment, the first signaling implicitly indicates the multiple radio resource pool.

In one embodiment, the first signaling is used to indicate frequency-domain resources occupied by each of the multiple radio resource pools.

In one embodiment, the first signaling is used to indicate time-domain resources occupied by each of the multiple radio resource pools.

In one embodiment, the first signaling is used to indicate a slot where each of the multiple radio resource pools is located.

In one embodiment, the first signaling is used to configure the multiple radio resource pool.

In one embodiment, at least one parameter value comprised in the first signaling is used to infer the multiple radio resource pool.

In one embodiment, the first information is used to indicate whether a PUSCH is transmitted in each of at least one radio resource pool among the multiple radio resource pools.

In one embodiment, a first one of the multiple radio resource pools is used to transmit the first information.

In one embodiment, the first information is transmitted in a radio resource pool other than the target radio resource pool among the multiple radio resource pools.

In one embodiment, a first one of the multiple radio resource pools is used to transmit a PUSCH, and the first information is multiplexed onto the PUSCH.

In one embodiment, a first one of the multiple radio resource pools is used to transmit a PUSCH, and the PUSCH carries the first information.

In one embodiment, a radio resource pool before the target radio resource pool among multiple radio resource pools is used to transmit the first information.

In one embodiment, the expression of “a radio resource pool other than the target radio resource pool among the multiple radio resource pools being used to transmit the first information” comprises: a radio resource pool before the target radio resource pool among the multiple radio resource pools is used to transmit a PUSCH, and the first information is multiplexed onto the PUSCH.

In one embodiment, the target radio resource pool is a last radio resource pool among the multiple radio resource pools.

In one embodiment, the target radio resource pool is a radio resource pool other than a first one of the multiple radio resource pools.

In one embodiment, the target radio resource pool is a first one of the multiple radio resource pools.

In one embodiment, from a time domain perspective, the first one of the multiple radio resource pools is an earliest radio resource pool among the multiple radio resource pools.

In one embodiment, from a time domain perspective, a last radio resource pool among the multiple radio resource pools is a latest radio resource pool among the multiple radio resource pools.

In one embodiment, each of the multiple radio resource pools is a PUSCH occasion.

In one embodiment, each of the multiple radio resource pools is an occasion used for a PUSCH.

In one embodiment, each of the multiple radio resource pools is an occasion used for a CG PUSCH.

In one embodiment, each of the multiple radio resource pools is reserved for a transmission of a PUSCH.

In one embodiment, each of the multiple radio resource pools is reserved for a transmission of a CG PUSCH.

In one embodiment, from frequency-domain and time-domain perspectives, each of the multiple radio resource pools comprises multiple REs.

In one embodiment, one of the multiple radio resource pools is a PUSCH occasion.

In one embodiment, one of the multiple radio resource pools is an occasion used for a PUSCH.

In one embodiment, one of the multiple radio resource pools is an occasion used for a CG PUSCH.

In one embodiment, one of the multiple radio resource pools is reserved for a transmission of a PUSCH.

In one embodiment, one of the multiple radio resource pools is reserved for a transmission of a CG PUSCH.

In one embodiment, from frequency-domain and time-domain perspectives, one of the multiple radio resource pools comprises multiple REs.

In one embodiment, the multiple radio resource pools are in a same CG period.

In one embodiment, the CG period is configured for an uplink transmission without dynamic grant.

In one embodiment, the CG period is a configured grant (CG) cycle.

In one embodiment, the CG period is configurable.

In one embodiment, the CG period comprises multiple symbols.

In one embodiment, the CG period comprises multiple slots.

### Embodiment 8

Embodiment 8 illustrates a schematic diagram of first information according to one embodiment of the present application, as shown in FIG. 8.

In embodiment 8, the first information comprises a bitmap, and any bit in the bitmap is used to indicate whether a PUSCH is transmitted in one of the multiple radio resource pools.

In one embodiment, the first information comprises multiple bits, and the multiple bits jointly indicate whether a PUSCH is transmitted in each of the multiple radio resource pools.

### Embodiment 9

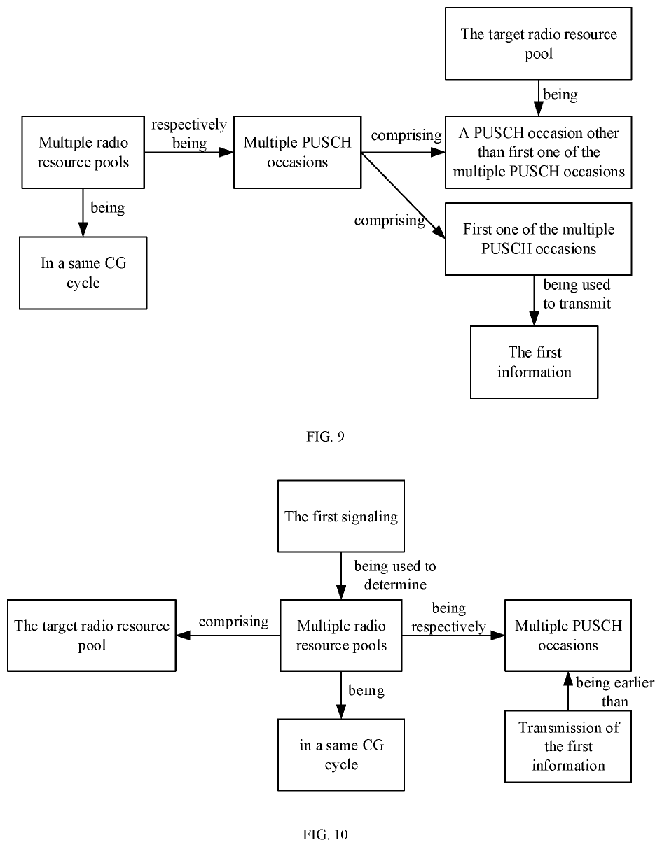

Embodiment 9 illustrates a schematic diagram of relations among multiple radio resource pools, multiple PUSCH occasions, a target radio resource pool as well as first information according to one embodiment of the present application, as shown in FIG. 9.

In embodiment 9, multiple radio resource pools are respectively multiple PUSCH occasions, and the target radio resource pool is a PUSCH occasion other than a first one of the multiple PUSCH occasions: the multiple radio resource pools are in a same CG period, and the first information is transmitted in the first one of the multiple PUSCH occasions.

In one embodiment, the multiple radio resource pools do not overlap with each other in time domain.

In one embodiment, the multiple radio resource pools are sequentially arranged in time domain.

In one embodiment, from a time domain perspective, the first one of the multiple PUSCH occasions is an earliest PUSCH occasion among the multiple PUSCH occasions.

In one embodiment, from a time domain perspective, a last one of the multiple PUSCH occasions is a latest PUSCH occasion among the multiple PUSCH occasions.

In one embodiment, the first information is multiplexed onto a PUSCH and then transmitted.

In one embodiment, the multiple radio resource pools are respectively in multiple different slots.

In one embodiment, the multiple radio resource pools respectively occupy different time-domain resources.

In one embodiment, the multiple radio resource pools are respectively multiple PUSCH occasions, the multiple radio resource pools are in a same CG period, and the first information is transmitted in a first one of the multiple PUSCH occasions.

In one embodiment, each of the multiple PUSCH occasions is a CG PUSCH occasion.

In one embodiment, each PUSCH occasion among the multiple PUSCH occasions is an occasion used for a PUSCH transmission.

In one embodiment, each PUSCH occasion among the multiple PUSCH occasions is an occasion used for a CG PUSCH transmission.

In one embodiment, each PUSCH occasion among the multiple PUSCH occasions is an occasion reserved for a PUSCH transmission.

In one embodiment, each PUSCH occasion among the multiple PUSCH occasions is an occasion reserved for a CG PUSCH transmission.

In one embodiment, the multiple radio resource pools are in a same CG period.

### Embodiment 10

Embodiment 10 illustrates a schematic diagram of relations among a first signaling, multiple radio resource pools, multiple PUSCH occasions, a target radio resource pool as well as first information according to one embodiment of the present application, as shown in FIG. 10.

In embodiment 10, the first signaling is used to determine multiple radio resource pools, and the target radio resource pool is one of the multiple radio resource pools, the multiple radio resource pools are respectively multiple PUSCH occasions, the multiple radio resource pools are in a same CG period, and the first information is transmitted before the multiple PUSCH occasions.

In one embodiment, the multiple radio resource pools do not overlap with each other in time domain.

In one embodiment, the meaning of the first information being transmitted before the multiple PUSCH occasions comprises: the first information is multiplexed onto a PUSCH and then transmitted, from a time domain perspective, the PUSCH is before the multiple PUSCH occasions.

In one embodiment, the meaning of the first information being transmitted before the multiple PUSCH occasions comprises: the first information is multiplexed onto a PUSCH and transmitted, from a time domain perspective, an end of the PUSCH is before an earliest symbol occupied by any of the multiple PUSCH occasions.

In one embodiment, the meaning of the first information being transmitted before the multiple PUSCH occasions comprises: the first information is multiplexed onto a PUSCH and then transmitted, from a time domain perspective, a slot where the PUSCH is located is before a slot where any of the multiple PUSCH occasions is located.

In one embodiment, the first information is multiplexed onto a PUSCH to be transmitted, and the PUSCH is in a same CG period as multiple PUSCH occasions.

### Embodiment 11

Embodiment 11 illustrates a structural block diagram of a processor in a first node, as shown in FIG. 11. In FIG. 11, a processor 1100 in a first node comprises a first receiver 1101 and a first transmitter 1102.

In one embodiment, the first node 1100 is a base station.

In one embodiment, the first node 1100 is a UE.

In one embodiment, the first node 1100 is a relay node.

In one embodiment, the first node 1100 is a vehicle-mounted communication device.

In one embodiment, the first node 1100 is a UE that supports V2X communications.

In one embodiment, the first node 1100 is a relay node that supports V2X communications.

In one embodiment, the first node 1100 is a UE that supports operations on high-frequency spectrum.

In one embodiment, the first node 1100 is a UE that supports operations on shared frequency spectrum.

In one embodiment, the first node 1100 is a UE that supports XR services.

In one embodiment, the first node 1100 is a UE that supports multicast transmission.

In one embodiment, the first receiver 1101 comprises at least one of the antenna 452, the receiver 454, the multi-antenna receiving processor 458, the receiving processor 456, the controller/processor 459, the memory 460 or the data source 467 in FIG. 4 of the present application.

In one embodiment, the first receiver 1101 comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1101 comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1101 comprises at least the first three of the antenna 452, the receiver 454, the multi-antenna receiving processor 458, the receiving processor 456, the controller/processor 459, the memory 460 and the data source 467 in FIG. 4 of the present application.

In one embodiment, the first receiver 1101 comprises at least the first two of the antenna 452, the receiver 454, the multi-antenna receiving processor 458, the receiving processor 456, the controller/processor 459, the memory 460 and the data source 467 in FIG. 4 of the present application.

In one embodiment, the first transmitter 1102 comprises at least one of the antenna 452, the transmitter 454, the multi-antenna transmitting processor 457, the transmitting processor 468, the controller/processor 459, the memory 460, or the data source 467 in FIG. 4 of the present application.

In one embodiment, the first transmitter 1102 comprises at least first five of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1102 comprises at least first four of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1102 comprises at least first three of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1102 comprises at least first two of the antenna 452, the transmitter 454, the multi-antenna transmitting processor 457, the transmitting processor 468, the controller/processor 459, the memory 460, and the data source 467 in FIG. 4 of the present application.

In one embodiment, the first receiver 1101 receives a first signaling, and the first signaling is used to determine a target radio resource pool: the first transmitter 1102 transmits first information; herein the first information is used to indicate whether a PUSCH is transmitted in the target radio resource pool: whether the first transmitter 1102 transmits a PUSCH in the target radio resource pool is related to at least one of the first information or whether the target radio resource pool has an overlapping with a characteristic resource, and the characteristic resource is a resource for at least one type of UCI: when any of a first condition or a second condition is satisfied, the first transmitter 1102 transmits a PUSCH in the target radio resource pool: the first condition comprises that the target radio resource pool has an overlapping with a characteristic resource, and the second condition comprises that the first information indicates transmitting a PUSCH in the target radio resource pool.

In one embodiment, a first condition set comprises at least the first condition and the second condition: when any condition in the first condition set is satisfied, the first transmitter 1102 transmits a PUSCH in the target radio resource pool: when all conditions in the first condition set are not satisfied, the first transmitter 1102 does not transmit a PUSCH in the target radio resource pool.

In one embodiment, when the first condition is satisfied and the first information indicates that a PUSCH is not transmitted in the target radio resource pool, the first transmitter 1102 transmits a PUSCH in the target radio resource pool.

In one embodiment, when the first condition is not satisfied and the first information indicates that a PUSCH is not transmitted in the target radio resource pool, the first transmitter 1102 does not transmit a PUSCH in the target radio resource pool.

In one embodiment, the first signaling is used to determine multiple radio resource pools, the target radio resource pool is one of the multiple radio resource pools, and a radio resource pool other than the target radio resource pool among the multiple radio resource pools is used to transmit the first information.

In one embodiment, the first information comprises a bitmap, and any bit in the bitmap is used to indicate whether a PUSCH is transmitted in one of the multiple radio resource pools.

In one embodiment, the multiple radio resource pools are respectively multiple PUSCH occasions, the multiple radio resource pools are in a same CG period, the first information is transmitted in a first one of the multiple PUSCH occasions, and the multiple radio resource pools do not overlap with each other in time domain.

In one embodiment, the target radio resource pool is a PUSCH occasion.

In one embodiment, the target radio resource pool is a CG PUSCH occasion.

In one embodiment, the first receiver 1101 receives a first signaling, and the first signaling is used to determine a target radio resource pool: the first transmitter 1102 transmits first information; herein, the first information is used to indicate whether a PUSCH is transmitted in the target radio resource pool: whether the first transmitter 1102 transmits a PUSCH in the target radio resource pool is related to at least one of the first information or whether the target radio resource pool has an overlapping with a characteristic resource, and the characteristic resource is a resource for at least one type of UCI: when the target radio resource pool overlaps with characteristic resource, the first transmitter 1102 transmits a PUSCH in the target radio resource pool: when the first information indicates transmitting a PUSCH in the target radio resource pool, and the first transmitter 1102 transmits a PUSCH in the target radio resource pool.

In one subembodiment of the above embodiment, the first signaling is one of a DCI comprising UL grant or a higher-layer parameter configuredGrantConfig, the first information is a UCI, and the target radio resource pool is a PUSCH occasion.

In one subembodiment of the above embodiment, when the target radio resource pool has no overlapping with characteristic resources and the first information indicates that a PUSCH is not transmitted in the target radio resource pool, the first transmitter 1102 does not transmit a PUSCH in the target radio resource pool.

In one embodiment, the first receiver 1101 receives a first signaling, and the first signaling is used to determine a target radio resource pool: the first transmitter 1102 transmits first information: herein, the first information is used to indicate whether a PUSCH is transmitted in the target radio resource pool: whether the first transmitter 1102 transmits a PUSCH in the target radio resource pool is related to at least one of the first information or whether the target radio resource pool has an overlapping with a characteristic resource, and the characteristic resource is a resource for at least one type of UCI: when the target radio resource pool has an overlapping with characteristic resources and a timeline condition for UCI multiplexing into a PUSCH is met, the first transmitter 1102 transmits a PUSCH in the target radio resource pool: when the first information indicates transmitting a PUSCH in the target radio resource pool, and the first transmitter 1102 transmits a PUSCH in the target radio resource pool.

In one sub embodiment of the above embodiment, the first signaling is one of a DCI comprising UL grant or a higher-layer parameter configuredGrantConfig, the first information is a UCI, and the target radio resource pool is a PUSCH occasion.

In one sub embodiment of the above embodiment, when the target radio resource pool has no overlapping with characteristic resources and the first information indicates that a PUSCH is not transmitted in the target radio resource pool, the first transmitter 1102 does not transmit a PUSCH in the target radio resource pool.

In one subembodiment of the above embodiment, when the target radio resource pool has an overlapping with characteristic resources and a timeline condition for UCI multiplexing into PUSCH is not met, and the first information indicates that a PUSCH is not transmitted in the target radio resource pool, the first transmitter 1102 does not transmit a PUSCH in the target radio resource pool.

### Embodiment 12

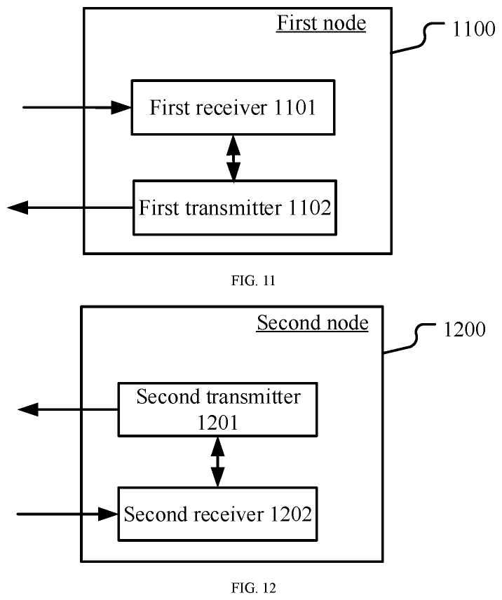

Embodiment 12 illustrates a structure block diagram of a processor in a second node, as shown in FIG. 12.

In FIG. 12, a processor 1200 in a second node comprises a second transmitter 1201 and a second receiver 1202.

In one embodiment, the second node 1200 is a UE.

In one embodiment, the second node 1200 is a base station.

In one embodiment, the second node 1200 is satellite.

In one embodiment, the second node 1200 is a relay node.

In one embodiment, the second node 1200 is a vehicle-mounted communication device.

In one embodiment, the second node 1200 is a UE that supports V2X communications.

In one embodiment, the second node 1200 is a device that supports operations on high-frequency spectrum.

In one embodiment, the second node 1200 is a device that supports operations on a shared spectrum.

In one embodiment, the second node 1200 is a device that supports XR services.

In one embodiment, the second node 1200 is one of testing devices, testing equipment, and testing instruments.

In one embodiment, the second transmitter 1201 comprises at least one of the antenna 420, the transmitter 418, the multi-antenna transmitting processor 471, the transmitting processor 416, the controller/processor 475 or the memory 476 in FIG. 4 of the present application.

In one embodiment, the second transmitter 1201 comprises at least the first five of the antenna 420, the transmitter 418, the multi-antenna transmitting processor 471, the transmitting processor 416, the controller/processor 475 and the memory 476 in FIG. 4 of the present application.

In one embodiment, the second transmitter 1201 comprises at least the first four of the antenna 420, the transmitter 418, the multi-antenna transmitting processor 471, the transmitting processor 416, the controller/processor 475 and the memory 476 in FIG. 4 of the present application.

In one embodiment, the second transmitter 1201 comprises at least the first three of the antenna 420, the transmitter 418, the multi-antenna transmitting processor 471, the transmitting processor 416, the controller/processor 475 and the memory 476 in FIG. 4 of the present application.

In one embodiment, the second transmitter 1201 comprises at least the first two of the antenna 420, the transmitter 418, the multi-antenna transmitting processor 471, the transmitting processor 416, the controller/processor 475 and the memory 476 in FIG. 4 of the present application.

In one embodiment, the second receiver 1202 comprises at least one of the antenna 420, the receiver 418, the multi-antenna receiving processor 472, the receiving processor 470, the controller/processor 475 or the memory 476 in FIG. 4 of the present application.

In one embodiment, the second receiver 1202 comprises at least first five of the antenna 420, the receiver 418, the multi-antenna receiving processor 472, the receiving processor 470, the controller/processor 475 and the memory 476 in FIG. 4 of the present application.

In one embodiment, the second receiver 1202 comprises at least first four of the antenna 420, the receiver 418, the multi-antenna receiving processor 472, the receiving processor 470, the controller/processor 475 and the memory 476 in FIG. 4 of the present application.

In one embodiment, the second receiver 1202 comprises at least first three of the antenna 420, the receiver 418, the multi-antenna receiving processor 472, the receiving processor 470, the controller/processor 475 and the memory 476 in FIG. 4 of the present application.

In one embodiment, the second receiver 1202 comprises at least first two of the antenna 420, the receiver 418, the multi-antenna receiving processor 472, the receiving processor 470, the controller/processor 475 and the memory 476 in FIG. 4 of the present application.

In one embodiment, the second transmitter 1201 transmits a first signaling, and the first signaling is used to determine a target radio resource pool: the second receiver 1202 receives first information: herein, the first information is used to indicate whether a PUSCH is transmitted in the target radio resource pool: whether the second receiver 1202 receives a PUSCH in the target radio resource pool is related to at least one of the first information or whether the target radio resource pool has an overlapping with a characteristic resource, and the characteristic resource is a resource for at least one type of UCI: when any of a first condition or a second condition is satisfied, the second receiver 1202 receives a PUSCH in the target radio resource pool: the first condition comprises that the target radio resource pool has an overlapping with a characteristic resource, and the second condition comprises that the first information indicates transmitting a PUSCH in the target radio resource pool.

In one embodiment, a first condition set comprises at least the first condition and the second condition: when any condition in the first condition set is satisfied, the second receiver 1202 receives a PUSCH in the target radio resource pool: when all conditions in the first condition set are not satisfied, the second receiver 1202 does not receive a PUSCH in the target radio resource pool.

In one embodiment, when the first condition is satisfied and the first information indicates that a PUSCH is not transmitted in the target radio resource pool, the second receiver 1202 receives a PUSCH in the target radio resource pool.

In one embodiment, when the first condition is satisfied and the first information indicates that a PUSCH is not transmitted in the target radio resource pool, the second receiver 1202 does not receive a PUSCH in the target radio resource pool.

In one embodiment, the first signaling is used to determine multiple radio resource pools, the target radio resource pool is one of the multiple radio resource pools, and the first information is received in a radio resource pool other than the target radio resource pool among the multiple radio resource pools.

In one embodiment, the first information comprises a bitmap, and any bit in the bitmap is used to indicate whether a PUSCH is transmitted in one of the multiple radio resource pools.

In one embodiment, the multiple radio resource pools are respectively multiple PUSCH occasions, the multiple radio resource pools are in a same CG period, the first information is received in a first one of the multiple PUSCH occasions, and the multiple radio resource pools do not overlap with each other in time domain.

In one embodiment, the target radio resource pool is a PUSCH occasion.

In one embodiment, the target radio resource pool is a CG PUSCH occasion.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals. NB-IOT terminals, vehicle-mounted communication equipment, aircrafts, diminutive airplanes, unmanned aerial vehicles, telecontrolled aircrafts and other wireless communication devices. The second node in the present application includes but is not limited to mobile phones, tablet computers, notebooks, network cards, low-consumption equipment, enhanced MTC (eMTC) terminals. NB-IOT terminals, vehicle-mounted communication equipment, aircrafts, diminutive airplanes, unmanned aerial vehicles, telecontrolled aircrafts and other wireless communication devices. The UE or terminal in the present application includes but is not limited to mobile phones, tablet computers, notebooks, network cards, low-consumption equipment, enhanced MTC (eMTC) terminals. NB-IOT terminals, vehicle-mounted communication equipment, aircrafts, diminutive airplanes, unmanned aerial vehicles, telecontrolled aircrafts, etc. The base station or network side equipment in the present application includes but is not limited to macro-cellular base stations, micro-cellular base stations, home base stations, relay base station, eNB, gNB, Transmitter Receiver Point (TRP), GNSS, relay satellites, satellite base stations, space base stations, test device, test equipment, test instrument and other radio communication equipment.

It would be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling, the first signaling being used to determine a target radio resource pool; and
a first transmitter, transmitting first information;
wherein the first information is used to indicate whether a PUSCH is transmitted in the target radio resource pool;
whether the first transmitter transmits a PUSCH in the target radio resource pool is related to at least one of the first information or whether the target radio resource pool has an overlapping with a characteristic resource, and the characteristic resource is a resource for at least one type of UCI: when any of a first condition or a second condition is satisfied, the first transmitter transmits a PUSCH in the target radio resource pool: the first condition comprises that the target radio resource pool has an overlapping with a characteristic resource, and the second condition comprises that the first information indicates transmitting a PUSCH in the target radio resource pool.

2. The first node according to claim 1, wherein a first condition set comprises at least the first condition and the second condition: when any condition in the first condition set is satisfied, the first transmitter transmits a PUSCH in the target radio resource pool: when all conditions in the first condition set are not satisfied, the first transmitter does not transmit a PUSCH in the target radio resource pool.

3. The first node according to claim 1, wherein when the first condition is not satisfied and the first information indicates that a PUSCH is not transmitted in the target radio resource pool, the first transmitter does not transmit a PUSCH in the target radio resource pool.

4. The first node according to claim 1, wherein the first signaling is used to determine multiple radio resource pools, the target radio resource pool is one of the multiple radio resource pools, and a radio resource pool other than the target radio resource pool among the multiple radio resource pools is used to transmit the first information.

5. The first node according to claim 4, wherein the first information comprises a bitmap, and any bit in the bitmap is used to indicate whether a PUSCH is transmitted in one of the multiple radio resource pools.

6. The first node according to claim 4, wherein the multiple radio resource pools are respectively multiple PUSCH occasions, the multiple radio resource pools are in a same CG period, the first information is transmitted in a first one of the multiple PUSCH occasions, and the multiple radio resource pools do not overlap with each other in time domain.

7. The first node according to claim 1, wherein a characteristic resource comprises a PUCCH resource.

8. A second node for wireless communications, comprising:
a second transmitter, transmitting a first signaling, the first signaling being used to determine a target radio resource pool; and
a second receiver, receiving first information;
wherein the first information is used to indicate whether a PUSCH is transmitted in the target radio resource pool; whether the second receiver receives a PUSCH in the target radio resource pool is related to at least one of the first information or whether the target radio resource pool has an overlapping with a characteristic resource, and the characteristic resource is a resource for at least one type of UCI: when any of a first condition or a second condition is satisfied, the second receiver receives a PUSCH in the target radio resource pool: the first condition comprises that the target radio resource pool has an overlapping with a characteristic resource, and the second condition comprises that the first information indicates transmitting a PUSCH in the target radio resource pool.

9. The second node according to claim 8, wherein a first condition set comprises at least the first condition and the second condition: when any condition in the first condition set is satisfied, the second receiver receives a PUSCH in the target radio resource pool: when all conditions in the first condition set are not satisfied, the second receiver does not receive a PUSCH in the target radio resource pool.

10. The second node according to claim 8, wherein when the first condition is not satisfied and the first information indicates that a PUSCH is not transmitted in the target radio resource pool, the second receiver does not receive a PUSCH in the target radio resource pool.

11. The second node according to claim 8, wherein the first signaling is used to determine multiple radio resource pools, the target radio resource pool is one of the multiple radio resource pools, and the first information is received in a radio resource pool other than the target radio resource pool among the multiple radio resource pools.

12. The second node according to claim 11, wherein the first information comprises a bitmap, and any bit in the bitmap is used to indicate whether a PUSCH is transmitted in one of the multiple radio resource pools:
or, wherein the multiple radio resource pools are respectively multiple PUSCH occasions, the multiple radio resource pools are in a same CG period, the first information is received in a first one of the multiple PUSCH occasions, and the multiple radio resource pools do not overlap with each other in time domain.

13. The second node according to claim 8, wherein a characteristic resource comprises a PUCCH resource.

14. A method in a first node for wireless communications, comprising:
receiving a first signaling, the first signaling being used to determine a target radio resource pool; and
transmitting first information;
wherein the first information is used to indicate whether a PUSCH is transmitted in the target radio resource pool; whether a PUSCH is transmitted in the target radio resource pool is related to at least one of the first information or whether the target radio resource pool has an overlapping with a characteristic resource, and the characteristic resource is a resource for at least one type of UCI: when any of a first condition or a second condition is satisfied, transmit a PUSCH in the target radio resource pool: the first condition comprises that the target radio resource pool has an overlapping with a characteristic resource, and the second condition comprises that the first information indicates transmitting a PUSCH in the target radio resource pool.

15. The method in a first node according to claim 14, wherein a first condition set comprises at least the first condition and the second condition; when any condition in the first condition set is satisfied, transmit a PUSCH in the target radio resource pool: when all conditions in the first condition set are not satisfied, does not transmit a PUSCH in the target radio resource pool.

16. The method in a first node according to claim 14, wherein when the first condition is not satisfied and the first information indicates that a PUSCH is not transmitted in the target radio resource pool, does not transmit a PUSCH in the target radio resource pool.

17. The method in a first node according to claim 14, wherein the first signaling is used to determine multiple radio resource pools, the target radio resource pool is one of the multiple radio resource pools, and a radio resource pool other than the target radio resource pool among the multiple radio resource pools is used to transmit the first information.

18. The method in a first node according to claim 17, wherein the first information comprises a bitmap, and any bit in the bitmap is used to indicate whether a PUSCH is transmitted in one of the multiple radio resource pools.

19. The method in a first node according to claim 17, wherein the multiple radio resource pools are respectively multiple PUSCH occasions, the multiple radio resource pools are in a same CG period, the first information is transmitted in a first one of the multiple PUSCH occasions, and the multiple radio resource pools do not overlap with each other in time domain.

20. The method in a first node according to claim 14, wherein a characteristic resource comprises a PUCCH resource.
